(19) United States
(12) Patent Application Publication
(10) Pub. No.: US 2015/0195320 A1
(43) Pub. Date: Jul. 9, 2015

(54) Method, System and Software Product for Improved Online Multimedia File Sharing

(71) Applicant: YOSEF AVRAHAM, HERZELIYA (IL)

(72) Inventor: YOSEF AVRAHAM, HERZELIYA (IL)

(21) Appl. No.: 14/588,440

(22) Filed: Jan. 1, 2015

Related U.S. Application Data
(60) Provisional application No. 61/923,250, filed on Jan. 3, 2014.

(51) Int. Cl. H04L 29/06

(52) U.S. Cl. CPC H04L 65/60; H04L 69/04

(57) ABSTRACT

The present invention describes methods, systems and software for improved information sharing over a public network, the system including an online application for uploading a compressed audio file (CAF) and a text vector (TV), which are synchronized over time by an internal first clock, a public network for storing the compressed audio file (CAF) and a text vector (TV) and comprising a system clock and a tool for downloading the compressed audio file (CAF) and a text vector (TV) with an internal second clock, wherein the internal first clock and internal second clock are synchronized with the system clock to form a synchronized emulated video.

### FIELD OF THE INVENTION

The present invention relates generally to improving communications over the internet, and more specifically to novel systems, methods and software products for versatile, online synchronized whiteboard and audio and video lessons on demand.

### BACKGROUND OF THE INVENTION

There is a wealth of knowledge owned by people, which is waiting to be shared with others, using the internet, in general and particularly in social networks. Most of the communication today is done via text files such as email, text messages and audio. There is an additional need for online teaching systems, conference systems and multi-person communication systems. Pupils no longer wish to sit in classrooms and look at a teacher, who is writing with chalk on a blackboard.

The format that is preferred by students today is video lessons. However, making a video lesson is a very difficult and time consuming task that requires effort, hardware and video editing knowledge.

Global companies have the need to enable communication between their employees and train them. Sometimes collogues need to sketch something to his colleague on the other side of the world and if the message was not clear, mistakes can happened that will cause losing time and money. Training using video and knowledge sharing in corporate consume time and extra efforts and sometimes drop because of luck of resources.

There is thus an unmet need to provide systems and methods that allow teachers to provide lessons, and for business associates to connect more completely over public communication networks while the most comprehensive way to do so is by video and real time visual communication.

### SUMMARY OF THE INVENTION

It is an object of some aspects of the present invention to provide a system and method for providing video-like communication means over a public communication network.

Prior art canvases were designed to enable drawing over HTML for static pictures that will be saved. The current invention enhances this functionality, by writing anything done on a whiteboard as a text vector format and then generating a stream file to simulate a video as a movie.

The systems of the present invention are constructed and configured to provide use of a canvas on a whiteboard with synchronized compressed audio files (CAFs) and text vectors (TVs) to provide a recipient with a video-like product, which is an emulation of a video.

The systems of the present invention are further constructed and configured to provide enhanced fast-forward for a recipient of a combination of the compressed audio files (CAFs) and text vectors (TVs) to a point in time requested.

The systems of the present invention are further constructed and configured to provide enhanced fast-backward for a recipient of a combination of the compressed audio files (CAFs) and text vectors (TVs) to a point in time requested.

The systems of the present invention are constructed and configured to provide improved introduction of a newcomer to a lesson-in-progress or video-in-progress.

The systems of the present invention are constructed and configured to provide simplified animation methods.

The present invention provides systems, methods and software products for enhanced synchronization of text vectors and audio files associated with the text vectors.

The present invention further provides systems, methods and software products for improved playback of videos with enhanced fast-forward capabilities.

The present invention further provides systems, methods and software products for improved playback of videos with enhanced fast-backwards capabilities.

The present invention further provides systems, methods and software products for improved real-time sharing videos between users with addition of new users into a running video session.

Some embodiments of the present invention provide a system and method for increasing interactions between students.

Some further embodiments of the present invention provide a system and method for increasing availability of learning material on a public communication network.

Some additional embodiments of the present invention provide an improved system and method for increasing remote interaction between business associates.

Additional embodiments of the present invention provide a system and method for creating video lessons without any specific hardware or installed software, from home.

Further embodiments of the present invention provide a system and method for creating a video in one click.

Yet further embodiments of the present invention describe a system and method for providing an online collaboration tool, which enables communication with nearly zero time delay.

Some additional embodiments of the present invention provide a system and method for creating a video lesson in HD format in a fraction of the size of standard HD video format.

The present invention provides improved methods, systems and software product for information sharing over a public network.

The present invention further provides improved methods, systems and software product for versatile devices that are connected to the internet and enable an online synchronized video and audio.

Different platforms require specific developments, which may yield inaccuracy and incompatibility between platforms that share the information. The HTML5 standard was developed in mind to support multiple devices, independent of the hardware or system operation that is used.

The present invention includes use of a new library of HTML5, named Canvas, which was designed to support graphic over user's webpage without the need for additional plug-in and using the new library and WebRTC, which enables recording of audio, video and peer-to-peer communication from the client's side using web browsers without the need to install any plug-in.

The present invitation describes enhancements of these new libraries and its unique usage.

The present invention further describes methods, systems and software for improved information sharing over a public network, the system including an online application for uploading a compressed audio file (CAF) and a text vector (TV), which are synchronized over time and which simulate a video lesson (although this is not a standard video); a public network for storing the compressed audio file (CAF) and a text vector (TV); and a tool for downloading the compressed audio file (CAF) and a text vector (TV) to form a synchronized video.

The compressed audio file (CAF) and a text vector (TV), which are synchronized over time may be uploaded in a one-click step.

The present invention describes the extension of the HTML5, canvas, standard library to support dynamic user's activity and document them for later presentation as a movie.

In some embodiments of the present invention, improved methods and systems are provided for improved engagement with a customer or user.

In other embodiments of the present invention, a method and system are described for providing improved online lessons to a plurality of customers or users.

In additional embodiments of the present invention, a method and system are described for providing improved online interactivity between geographically remote individuals or companies.

In additional embodiments of the present invention, a method and system are described for providing animation in one-click.

There is thus provided according to an embodiment of the present invention, a system for improved multimedia file sharing over a public network, the system including;
a) an online application for uploading a compressed audio file (CAF) and a text vector (TV), which are synchronized over time by an internal first clock;
b) a public network for storing the compressed audio file (CAF) and a text vector (TV); and
c) a tool for downloading the compressed audio file (CAF) and a text vector (TV) with an internal second clock, wherein the internal first clock and internal second clock are synchronized with a system clock to form a synchronized video.

Additionally, according to an embodiment of the present invention, the compressed audio file (CAF) and the text vector (TV) are uploaded, stored and downloaded separately.

Furthermore, according to an embodiment of the present invention, the tool enables downloading to a device.

Moreover, according to an embodiment of the present invention, the device is a Personal Computer (PC) or a portable communications device is selected from the group consisting of a laptop, cellular phone, a mobile phone, a mobile device, a computer, a speaker set, a television and a tablet device.

Further, according to an embodiment of the present invention, the device further includes a whiteboard display.

Yet further, according to an embodiment of the present invention, the system is constructed to extend an HTML5/Canvas standard library to support activities over time, synchronized to the compressed audio file (CAF).

Furthermore, according to an embodiment of the present invention, the system further includes a text vector sorting tool adapted to sort elements into an array over time and further to arrange all instructions associated with each element over the time. Additionally, according to an embodiment of the present invention, the system further includes a text vector sorting tool adapted to sort elements into an array over time and further to arrange all instructions associated with each element over the time.

There is thus provided according to another embodiment of the present invention, a method for improved multimedia files sharing over a public network, the method including;
a) uploading a pre-synchronized compressed audio file (CAF) and a graphic-to-text vector (GTT) to a public network;
b) storing the compressed audio file (CAF) and a graphic-to-text vector (GTT) on the public network; and
c) downloading the compressed audio file (CAF) and a text-to-graphics vector (TTG) to a user device, wherein the graphic-to-text vector (GTT) and the text-to-graphics vector (TTG) are synchronized internally and are both synchronized with a system clock to form a synchronized emulated video.

Further, according to an embodiment of the present invention, the method extends an HTML5/Canvas standard library to support activities over time synchronized to the compressed audio file (CAF).

Furthermore, according to an embodiment of the present invention, the uploading step is performed in one click to create the synchronized video.

Additionally, according to an embodiment of the present invention, the method further includes sorting text vectors by sorting elements into an array over time and further arranging all instructions associated with each element over the time (t₀ to tₙ).

Further, according to an embodiment of the present invention, the method further includes fast-forwarding the synchronized video or emulated video to a point in time t₁, by;
a) taking a snapshot of all instructions execute at time t₁ for all the elements; and
b) executing all the instructions.

Interestingly, according to an embodiment of the present invention, the method further includes;
c) fast-reversing to a point in time t₁ by going to t₀,
d) taking a snapshot of all instructions active at time t₁ for all the elements; and
e) activating all the instructions.

Additionally or alternatively, according to an embodiment of the present invention, the method further includes;
c) fast-reversing to a point in time t₁ by back-executing all instructions of all elements from tₙ to t₁; and
d) taking a snapshot of all instructions active at time t₁ for all the elements; and
e) activating all the instructions of step b).

Further, according to an embodiment of the present invention, the synchronized video is activated in one-click.

There is thus provided according to an embodiment of the present invention, a computer software product, the product configured for improved multimedia files sharing information sharing over a public network, the product including a computer-readable medium in which program instructions are stored, which instructions, when read by a computer, cause the computer to;
a) upload a pre-synchronized compressed audio file (CAF) and a graphic-to-text vector (GTT) to a public network;
b) store the compressed audio file (CAF) and a graphic-to-text vector (GTT) on the public network; and
c) download the compressed audio file (CAF) and a text-to-graphics vector (TTG) to a user device, wherein the graphic-to-text vector (GTT) and the text-to-graphics vector (TTG) are synchronized internally and are both synchronized with a system clock to form a synchronized video.

Further, according to an embodiment of the present invention, the product is adapted to extend an HTML5/Canvas standard library to support activities over time synchronized to the compressed audio file (CAF).

Furthermore, according to an embodiment of the present invention, the upload enables a one-click step to create a synchronized video.

Additionally, according to an embodiment of the present invention, the product is configured for improved information sharing over a public network, the product is extending the HTML5/Canvas standard library to support activities over time synchronized to audio file.

Additionally, according to an embodiment of the present invention, the system clock is adapted to disable an accumulative gap between two or more real-time activities

Furthermore, according to an embodiment of the present invention, the method further includes;
d) repeating steps a) to c) in an online session; and
e) introducing a newcomer to said an online session by holding steps a) to
c) until said newcomer is updated.

Additionally, according to an embodiment of the present invention, the synchronized emulated video creating emulated video requires a fraction of SAID size of a standard HD format.

There is thus provided according to an embodiment of the present invention, a method for creating a one-click animation without usage of a timeline, said method including;
a) creating a plurality of animation elements on a whiteboard, each with predefined animation attributes; and
b) one-clicking on at least one of said elements at at least one time in an online session to activate said predefined animation attributes associated with each said animation elements at a respective time in said online session.

The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is simplified pictorial illustration of a system for improved information sharing over a public network, in accordance with an embodiment of the present invention;

FIG. 2 is a simplified description of the system's main block of a method for uploading information over a public network, in accordance with an embodiment of the present invention;

FIG. 3 is a simplified schematic flowchart of a method for uploading information over a public network, in accordance with an embodiment of the present invention;

FIG. 4 is a simplified schematic flowchart of a method for downloading information over a public network, in accordance with an embodiment of the present invention;

FIG. 5A is a simplified schematic flowchart of a the HTML5/canvas library extension method for uploading information over a public network, in accordance with an embodiment of the present invention;

FIG. 5B is a simplified schematic flowchart of a the HTML5/canvas library extension method for downloading information over a public network, in accordance with an embodiment of the present invention;

FIG. 6 is a screenshot of a generalized whiteboard in an application, in accordance with an embodiment of the present invention;

FIG. 7 is a screenshot of a generalized whiteboard in a user recording audio step and user graphic activities over the whiteboard in an application, in accordance with an embodiment of the present invention;

FIG. 8 is a screenshot of a generalized whiteboard in a user downloading lesson and playing synchronized video and audio step in an application, in accordance with an embodiment of the present invention;

FIG. 9 is a simplified schematic flowchart of a graphic-to-text method and text-to-graphic method for sharing information over a public network, in accordance with an embodiment of the present invention

FIG. 10 is a simplified schematic flowchart of a multi-participant session in a method for imparting information over a public network, in accordance with an embodiment of the present invention;

FIG. 11 is a is a screenshot of an animated element on a whiteboard application, in accordance with an embodiment of the present invention;

FIG. 12 is a simplified schematic illustration of a system for synchronizing time in imparting information over a public network, in accordance with an embodiment of the present invention;

FIG. 13 is a simplified schematic flowchart of a rapid method for fast-forwarding a video from a recipient side, in accordance with an embodiment of the present invention;

FIG. 14A is a simplified schematic illustration of a method for sorting text vectors into elements and their associated instructions over time, in accordance with an embodiment of the present invention;

FIG. 14B is a simplified schematic illustration of table of sorted elements from the method of FIG. 14A, in accordance with an embodiment of the present invention; and

FIG. 15 is a simplified schematic flowchart of a rapid method for fast-reversing a video from a recipient side, in accordance with an embodiment of the present invention.

In all the figures similar reference numerals identify similar parts.

### DETAILED DESCRIPTION OF PREFERRED EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

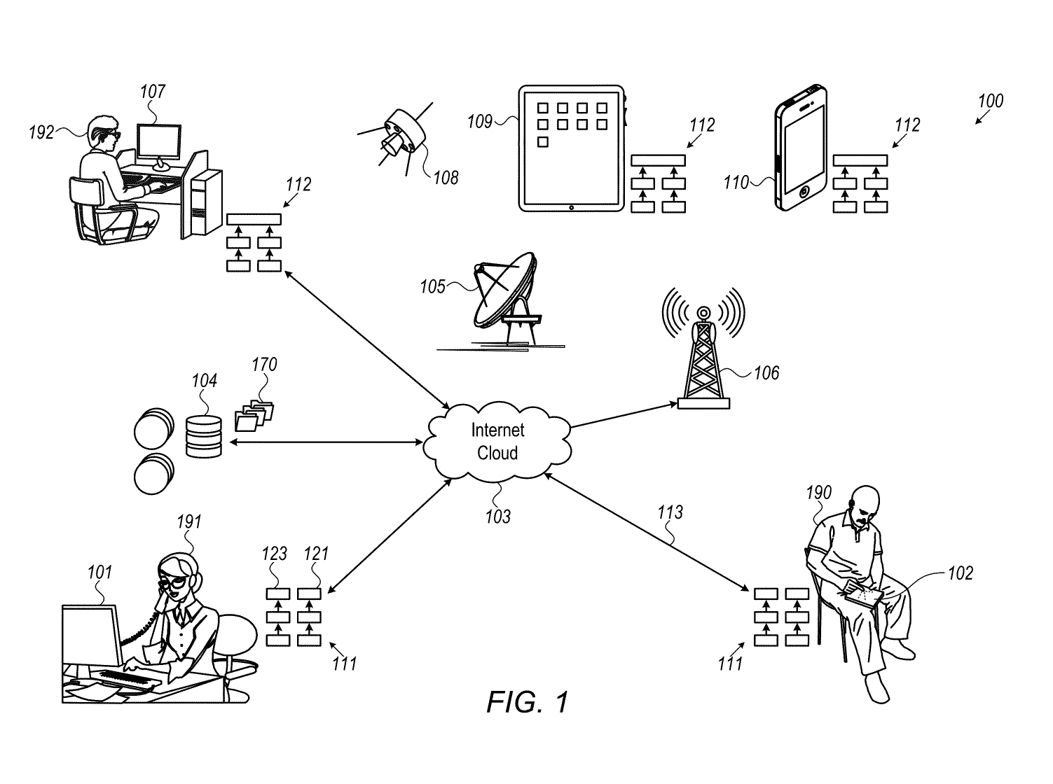

Reference is now made to FIG. 1, which is a simplified pictorial illustration showing a system 100 for improved online emulated video sharing over a public network, in accordance with an embodiment of the present invention.

Emulated video (definition)—Emulated video looks to the end user like a regular video however it uses a different mechanism to draw and move objects over the time with parallel audio layer synchronization to the movement. The systems and methods of the present invention uses batches of command to describe users activity over time and document them in a log file, A recording of audio channel is performed in parallel. The player used by the present invention is an encoder that reads the instruction with respect to the time they were created and converts the commands to graphic and motion and in parallel stream the audio. This dual streaming of text instruction converted to graphic motion with audio layer creates and emulation of a video.

System 100 typically includes a server utility 104, internet cloud 103, communication between clients/user devices 101, 102, 107, 109 and 110 either via wired network 113 or via wireless connections 105, 106 and 108. System 100 typically includes an upload mechanism 111, which converts the users 190, 191 activities and voice, which are captured by system 100 into a text vector (TV) file 121 and compressed audio file (CAF) 123. The upload may be performed in a one-click operation. These are separately transmitted over the internet 103 and stored on the server 104 and/or in cloud 103.

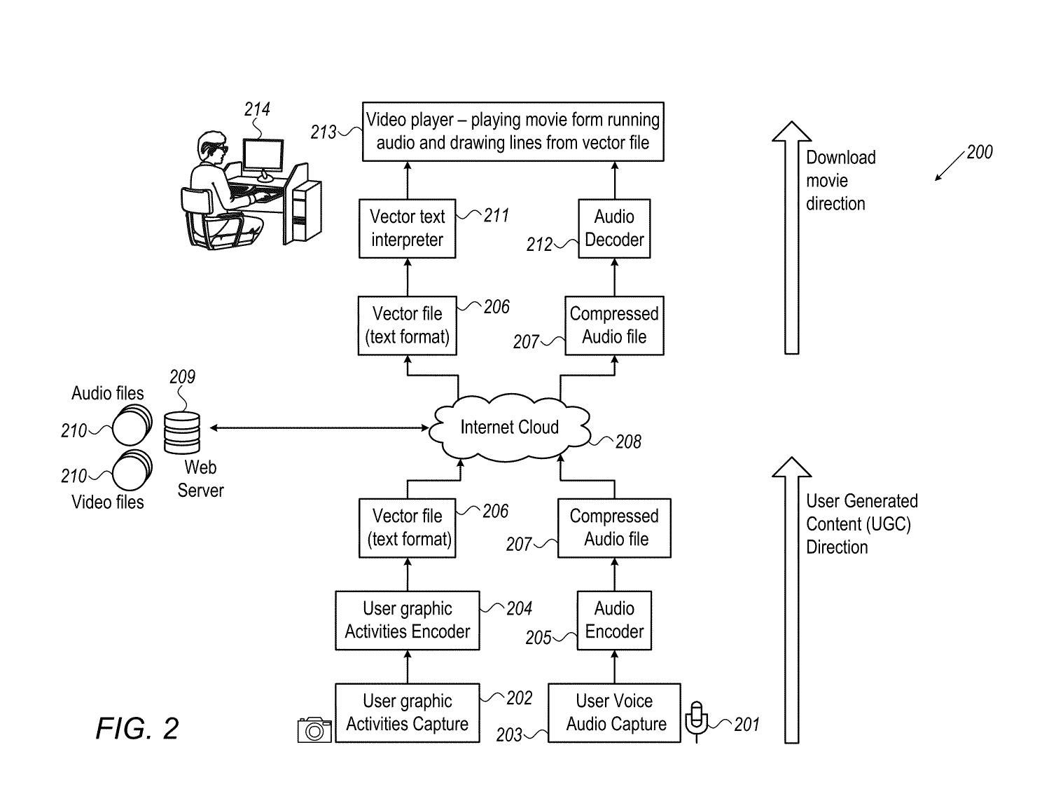

System 100 comprises an audio encoder and a text vector (TV) interpreter 112 which converts the CAF and TV into a “video-like” movie. The user/recipient such as person 192 can obtain a specific video from a large library 170 of. Further details of the methods are described herein below with reference to FIGS. 2-5B, and 13-15.

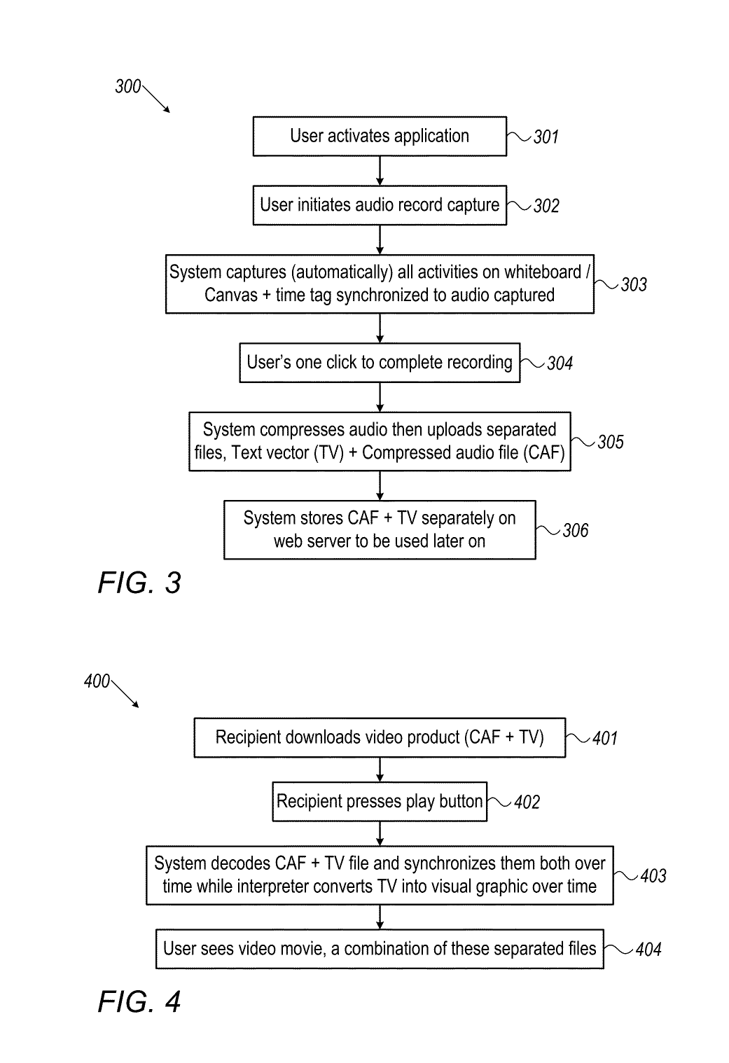

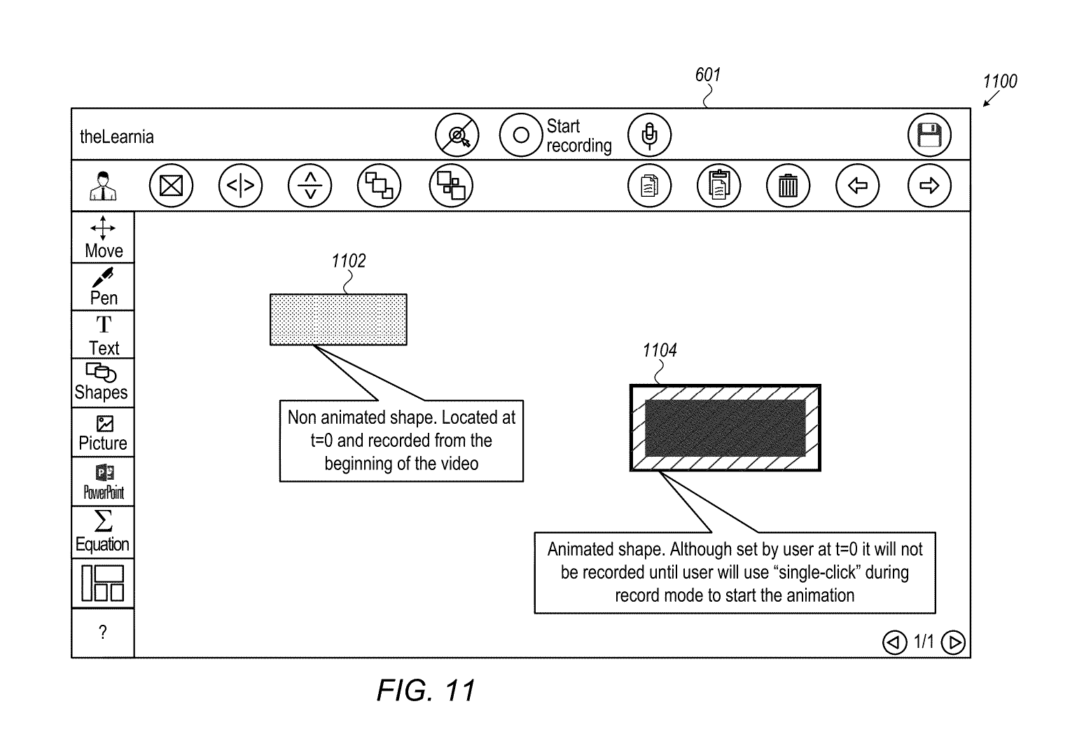

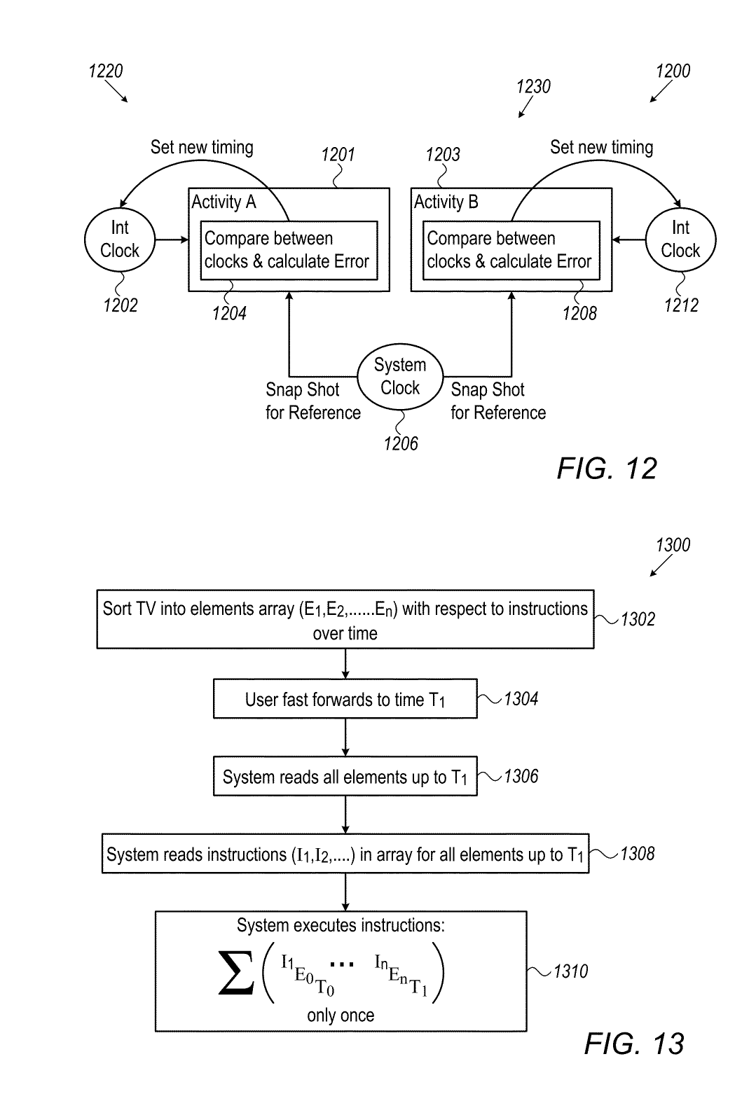

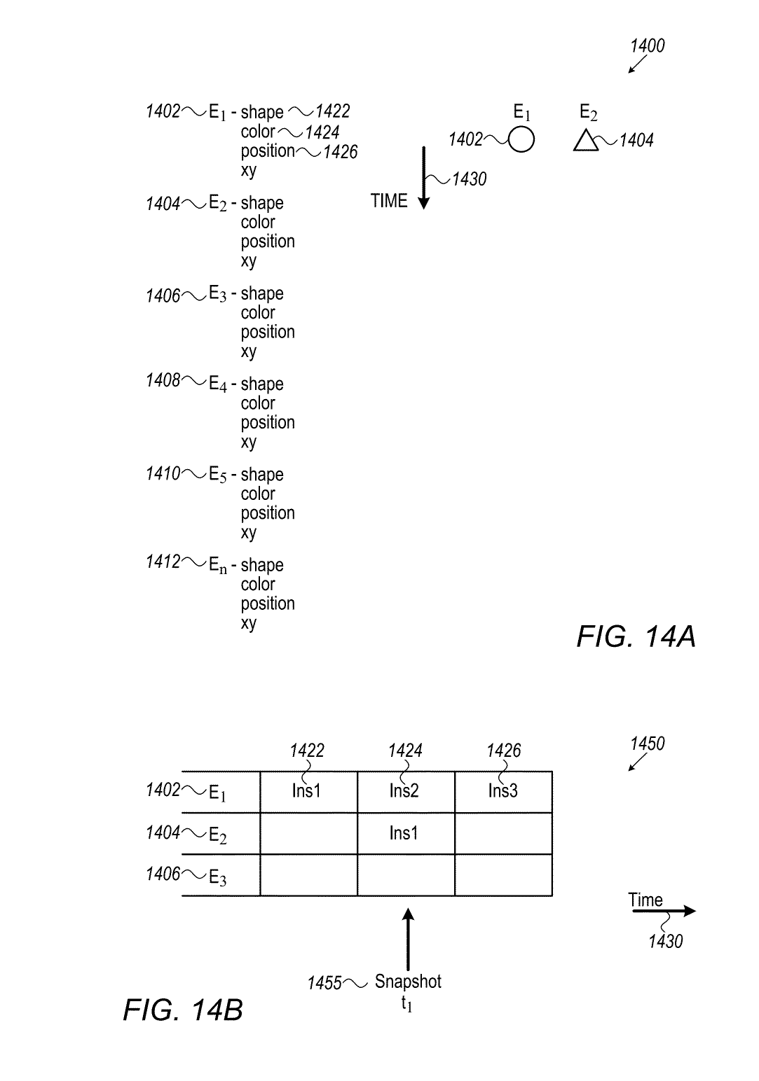

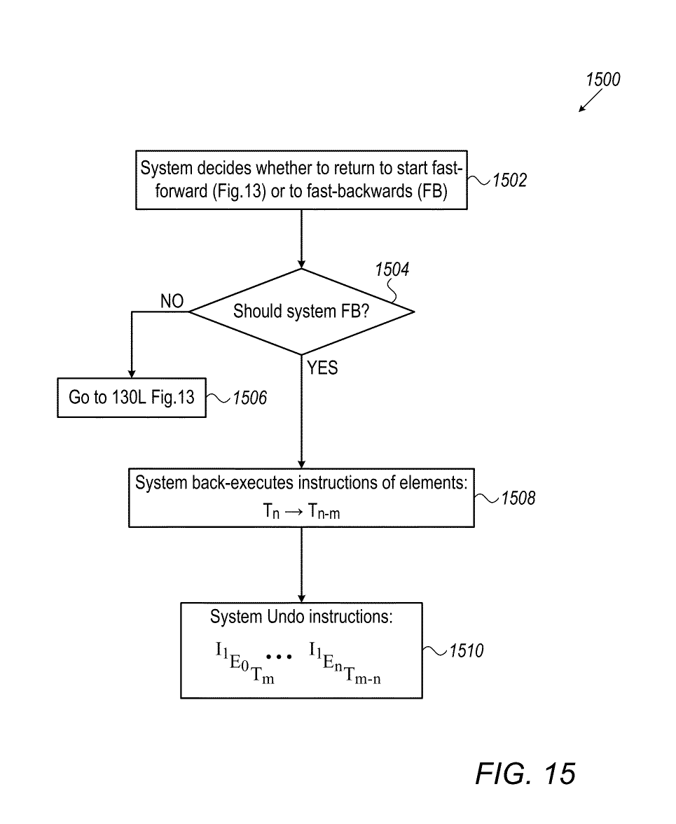

The systems (such as systems 100 FIG. 1 and 200 FIG. 2) of the present invention are constructed and configured to provide several novel features: —
1) Use of a Canvas/whiteboard with synchronized compressed audio files (CAFs) and text vectors (TVs) to provide a recipient with a video-like product, which is not actually video (FIGS. 3-5B and 12);
2) Improved introduction of a newcomer to a lesson-in-progress or session-in-progress (FIG. 10);
3) Simplified animation methods (FIG. 11);
4) Enhanced fast-forward for a recipient of a combination of the compressed audio files (CAFs) and text vectors (TVs) to a point in time requested (FIG. 13); and
5) Enhanced fast-backward for a recipient of a combination of the compressed audio files (CAFs) and text vectors (TVs) to a point in time requested (FIG. 15).

Reference is now made to FIG. 2, which is a simplified pictorial description of the system's main block showing a system 200 for improved emulated video sharing over a public network, in accordance with an embodiment of the present invention. System 200 may be similar or identical to system 100 (FIG. 1).

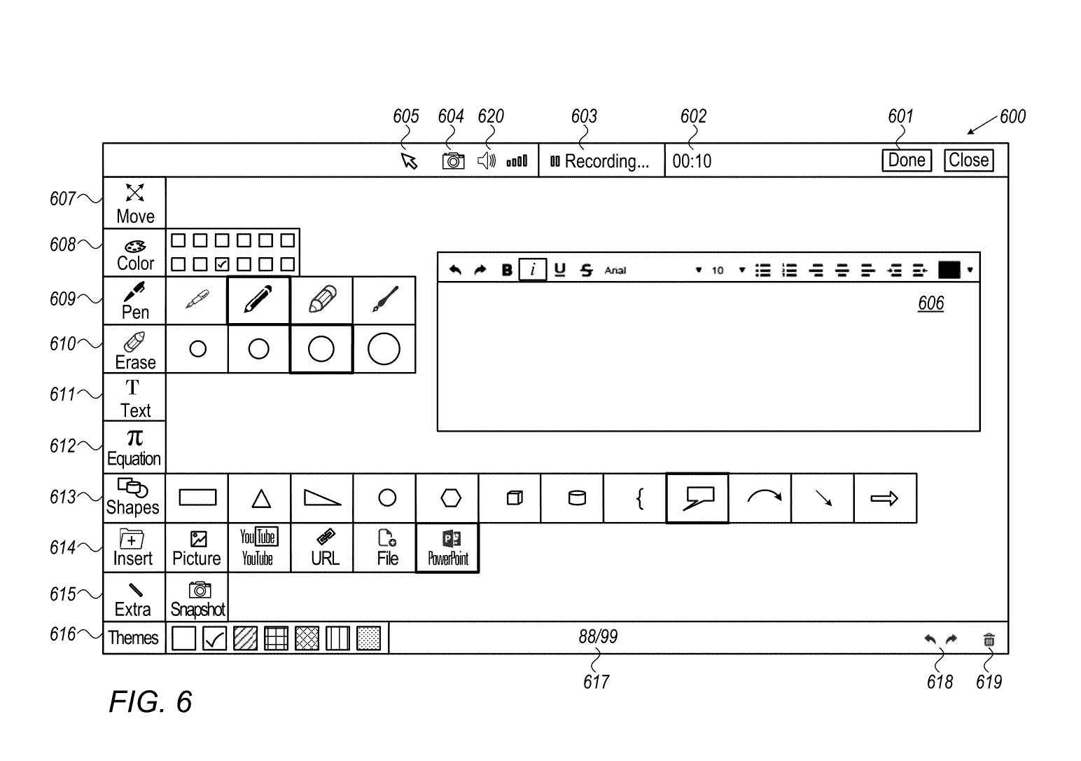

User activities on canvas/whiteboard (shown schematically in FIGS. 6-8 as 600, 700, 800 respectively) are captured by the user graphic activity capture mechanism 202, which stores all activities in a log file and adding a time stamp for each operation. All activities are capture in their sequential order.

An audio device such as microphone 201 senses the audio and user voice audio capture mechanism 203 is responsible to capture and store in user's client device. The user graphic activities encoder 204 translates the activities into a text file while the audio encoder 205 is responsible to decode and compress the audio. Vector file 206 and compressed audio file (CAF) 207 are now ready to be transmitted to the server.

System 200 copies the files generated by the user and sends them to the web server 209 over the internet cloud 208 either via wired or wireless connection, as is known in the art. Files 210 are now stored and ready to be used by others.

User 214 can download a video data by sending request to server 209. Files 210 are downloaded via internet cloud 208 and copied into user's device internal memory as a separate files text vectors (TV) 206 and compressed audio file (CAF) 207. Vector text interpreter 211 is responsible to read the text file stream them to the canvas library. Audio decoder 212 is responsible to encode the compress audio file. Video player 213 combines the graphic activities with the audio file and presents them on user's client screen 214 as an emulated video.

System 200 may also operate through communication protocols between computers over the Internet which technique is known to a person versed in the art and will not be elaborated herein. As will readily be appreciated, this is a very simplified description, although the details should be clear to the artisan.

Also, it should be noted that the invention is not limited to the user-associated communication devices—computers and portable and mobile communication devices—and a variety of others such as an interactive television system may also be used.

It should be understood that many variations to system 200 are envisaged, and this embodiment should not be construed as limiting. For example, interactive televisions may be used for inputting and receiving data from the Internet using the same mechanism and can interact with other mobile devices.

The software applications of the present invention use a vector file that is sent to the server 209 (FIG. 2). This saves a lot of bandwidth and time, yet keeps the resolution at a maximum. This invention enables the addition of shapes, and text. As is seen in FIG. 6, the present invention provides a whiteboard with a full set of features shapes drawing and text. These tools help a user when he/she prepares his/her video. These are then all converted to vector text files so that they can be downloaded very fast even for mobile device users.

A fuller understanding of the methodology for combining CAF and TV of the present invention is exemplified in FIGS. 3-5.

Reference is now made to FIG. 3, which is a simplified schematic flowchart 200 of a method for uploading information over a public network, in accordance with an embodiment of the present invention.

In an activating step 301, a user, such as user 190 (FIG. 1), activates the application on his/her device 101, 102, 107, 109 or 110.

In an initiating step 302, he/she initiates audio record capture.

In an automatic capture step 303, system 200 is automatically capture all activities done by user's whiteboard 101, 102 and adding time tag to assure audio files 207 will be synchronized with text vector 206.

The user performs an on screen one click operation to complete recording in a complete recording step 304. This creates a video lesson or other video in a one-click step.

The system is then operative to separately upload a compressed audio file (CAF) 207 and a text vector 206 associated with the user's recording session, in an uploading step 305.

Thereafter, the compressed audio file (CAF) 207 and text vector (TV) 206 are stored separately in cloud server 209 in a storing step 306.

At a later time, another user is interested to see and hear a lesson uploaded by users 191, 192.

Reference is now made to FIG. 4, which is a simplified schematic flowchart 200, of a method for downloading information over a public network, in accordance with an embodiment of the present invention.

In a product downloading step 401, user 192, downloads a product, such as lesson uploaded by user 191, 190. Further details of this step are described with respect to FIG. 13 herein below.

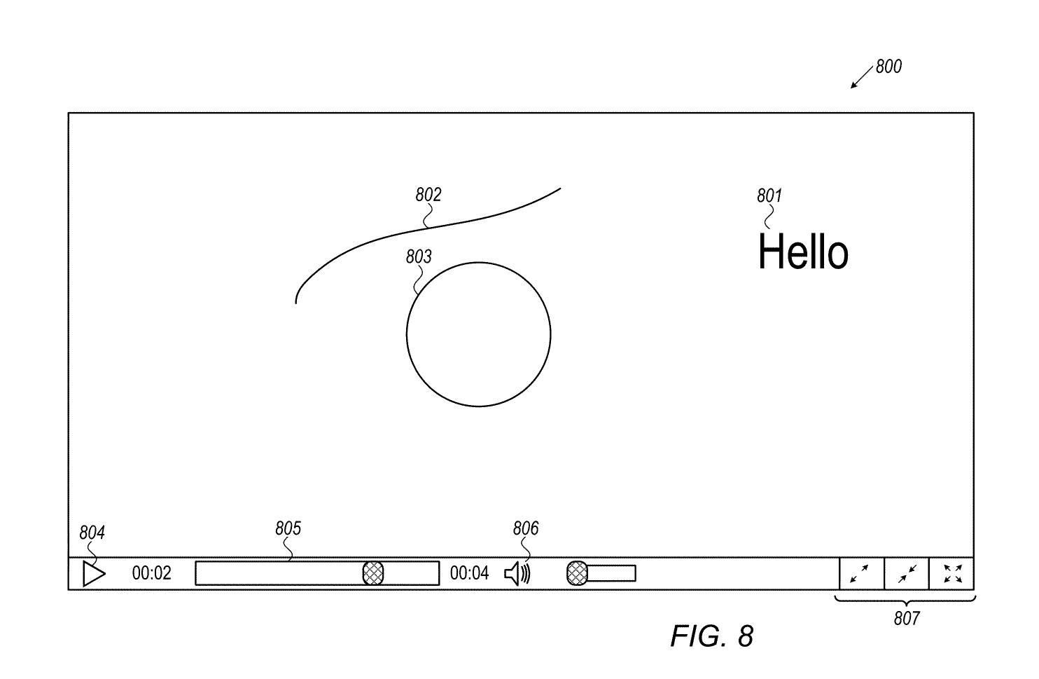

In a pressing button step 402, a recipient, such as user 192 presses an onscreen play button action 804 (FIG. 8).

In a decoding step 403, decoders 211, 212 (FIG. 2) are operative to synchronize the upload of the compressed audio file (CAF) and text vector (TV) and to decode text into visual graphic over to user 192's device 107 screens.

It should be noted that the system and method of the present invention provides user 192 with the experience of viewing a video, whereas, in fact he/she is perceiving two synchronized files (CAF+TV, as described hereinabove). These files are loaded and highly synchronized in accordance with the method of the present invention and system, described with reference to FIG. 12 herein below.

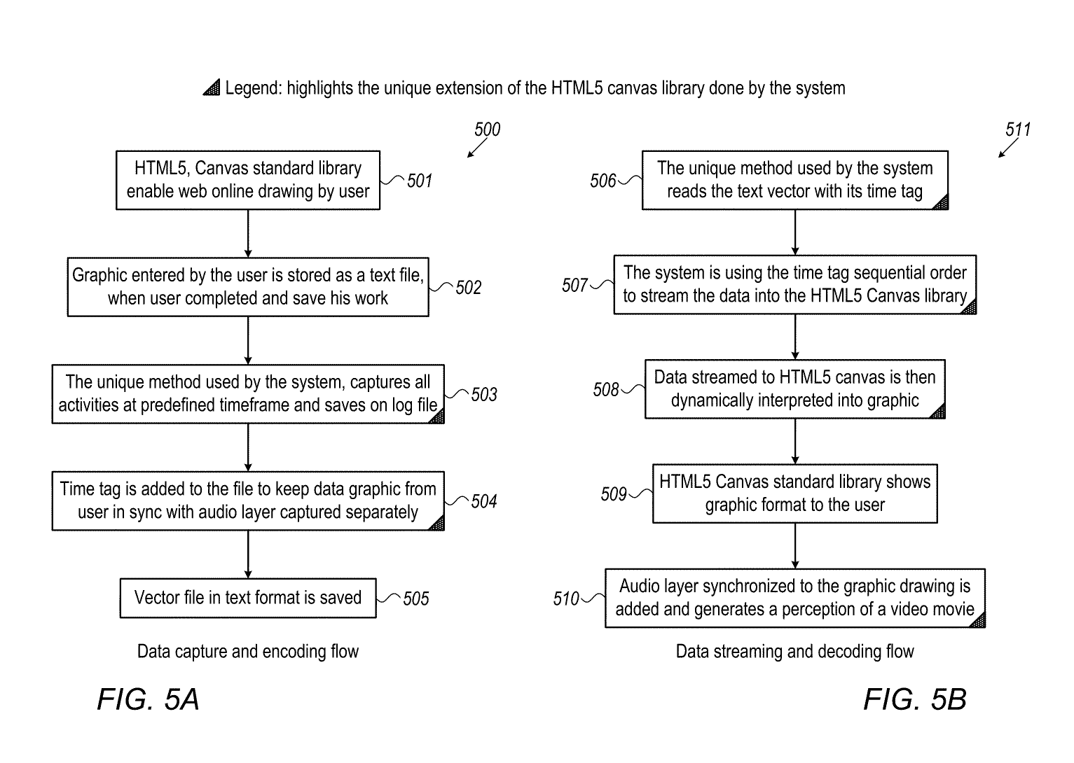

Reference is now made to FIG. 5A, which is a simplified schematic flowchart 500 of the HTML5/canvas library extension method for uploading information over a public network, in accordance with an embodiment of the present invention. This method is actually an extension made for a standard Canvas to create simulated video from static graphic canvas. Furthermore, turning to FIG. 5B, there is seen a simplified schematic flowchart 511 of a HTML5/canvas library extension method for downloading information over a public network, in accordance with an embodiment of the present invention. This methodology is actually an extension of a standard Canvas to interpose vector data to simulate a video from the standard static graphic canvas.

In steps 501 and 502 the system uses a standard method of the canvas to capture graphic activities performed by users 190, 191.

In step 503, the present invention uses a unique method to capture all activities over time with clock synchronization to eliminate any clock drift over time (as shown with respect to FIG. 12 herein).

In step 504, the present invention uses a unique time tag to keep the graphic coming from the user to always be in synchronization with the audio layer captured separately.

In step 505, system uses a standard text format to save all activities.

In step 506, the present invitation uses a unique method to read the text vector with its time tag. In steps 507 and 508 the system interprets the information stored at the text vector and streams it over time to the canvas library (as a command after command).

In step 509, the system uses the canvas standard library to draw the text vector commands as a graphic. In step 510, the system projects both an audio separated layer with the graphic drawings to perform the perception of video movie to users 190, 191, 192.

The present invention uses a technique to reduce overload from CPU, when reading and executing huge number of command lines in prior art system, which need to perform a huge amount of interactions, thereby overloading systems, even with strong CPUs. Prior-art real-time recording log activities additionally heavily overload the CPU usage of an end user device (such as 107, FIG. 1), since it has to document all activities every few milliseconds. On top of that, the CPU is utilized in prior art methods, with audio capturing at a high rate to maintain audio quality.

Even strong computers with multiple CPU cores find these prior art methodology tasks highly demanding. Since both activities capture and audio capture are performed in separated layers, it is very common that each of the activities will race on the same CPU resource, causing a delay of one activity to the other activity. Since both activities are real-time in nature, any delay in capturing (audio or user activity) will induce a synchronization lag between the audio and the video.

Lagging between audio and video of more than 300 ms is noticeable by the user and also accumulates over time of recording since such clashes between audio and activity recording always happens (and cannot be prevented using prior art methods). In order to avoid accumulation over time and compensate the lagging phenomena, the present invention uses special lagging cancellation techniques, as is described hereinabove with reference to FIG. 12.

Turning to FIG. 12, there is a simplified schematic illustration of a system 1200 for synchronizing time in imparting information over a public network, in accordance with an embodiment of the present invention.

System 1200 is constructed and configured to cancel lagging of CAF playing, for example behind the TV.

An internal CPU clock 1202, 1212 is respectively associated with activity A, 1201 and activity B, 1203 for two independent operation systems, 1220, 1230.

An independent system CPU clock 1206 is used as an reference for clocks 1202 and 1212. The CPU clock is considered as the highest priority task of all, due to that fact many real-time applications rely on CPU high priority clock to be the most accurate process. The present invention uses the (absolute) system operation clock 1206 timing to compensate for a lag in a case in which one activity of 1201, 1203 consumes more CPU time on behalf of the other process hence causing lag of the other side's internal clock.

One non-limiting example is shown as follows: —

Activity A (1201)—records user activity on whiteboard 800 and documents it in text log file and Activity B (1203) records user audio.

Each of the activities uses respective internal clocks 1202, 1212 to measure and document the time from the minute user press the RECORD button and until it is stopped/paused by the user.

Before a user presses a record button (such as 603, FIG. 6), the internal time of each activity is set to t=0 and at the minute the user presses RECORD, both activities take a snapshot. System operation clock 1206 of system 100 (FIG. 1) is used as a reference by both internal clocks 1202, 1212. This snapshot is taken again if user presses the pause and resumes recording.

Let it be assumed that activity B needs more CPU resources than activity A, it will cause a slight pause/delay of its internal clock and the system will go out of synchronization between the clocks 1202, 1212. (Activity A and Activity B are no longer documenting the same timing).

Upon releasing the CPU by Activity B, activity A will continue to record the timing but it will be different from the timing of Activity B.

Each of the activities has a special command to check the operation system timing every predefined period. As long as the time of the “current system operation”—“reference time of system operation” is zero, there is thus no need for compensation.

If any of the internal clocks is not aligned with the formula above (i.e “current system operation”−“reference time of system operation” is greater than zero), then the internal clock of the designated activity will deleted and the new time will be set instead. These techniques will eliminate any accumulated gap that is longer than 300 ms (a noticeable delay to human)

The present invention uses a technique of recording of all a user's activity on a whiteboard and documents the activity as a text file. This technique has a great advantage of significant size reduction (comparing to a video standard screen capturing). The methods of the present invention reduce the size of files for transfer over a public network.

Reference is now made to FIG. 6, which is a screenshot 600 of a generalized whiteboard in a device 101, 102, 107, 109, 110 in accordance with some embodiments of the present invention.

Whiteboard 600 is constructed and configured to be a sketch board, which enables insertion of themes 616.

The present invention further provides a means to create and share a video lesson in a single click by pressing the done button 601. If pressed, the system will encode the audio file into a compressed file and thereafter, upload and store it on the cloud server 209 (FIG. 2).

The present invention further provides an online collaboration tool is constructed and configured to enable video and voice conference with an interactive whiteboard (such as whiteboards 600, 700, 800).

The purpose of the whiteboard is to enable each of the participants in the session to sketch, delete, add a picture, shape or template, so that all participants will see the changes on their whiteboard in real-time.

The present invention further provides a user with a set of shapes to insert shapes 613, equations 612, text 611 and 606, pen sketch tool of varying thicknesses 609, colors 608; video, picture, files from other source 614 and an extra tool 615 planned in future.

The whiteboard further comprises an icon to erase drawing 610, move objects 607 add/delete multiple pages 617, 619 and undo/redo mechanism 618.

Additionally, the whiteboard comprises a recording/pause button 603 with time indication 602, a video camera insertion layer 604, audio level indication and control 620 and cursor tracker 605 to show user activity over the whiteboard 600.

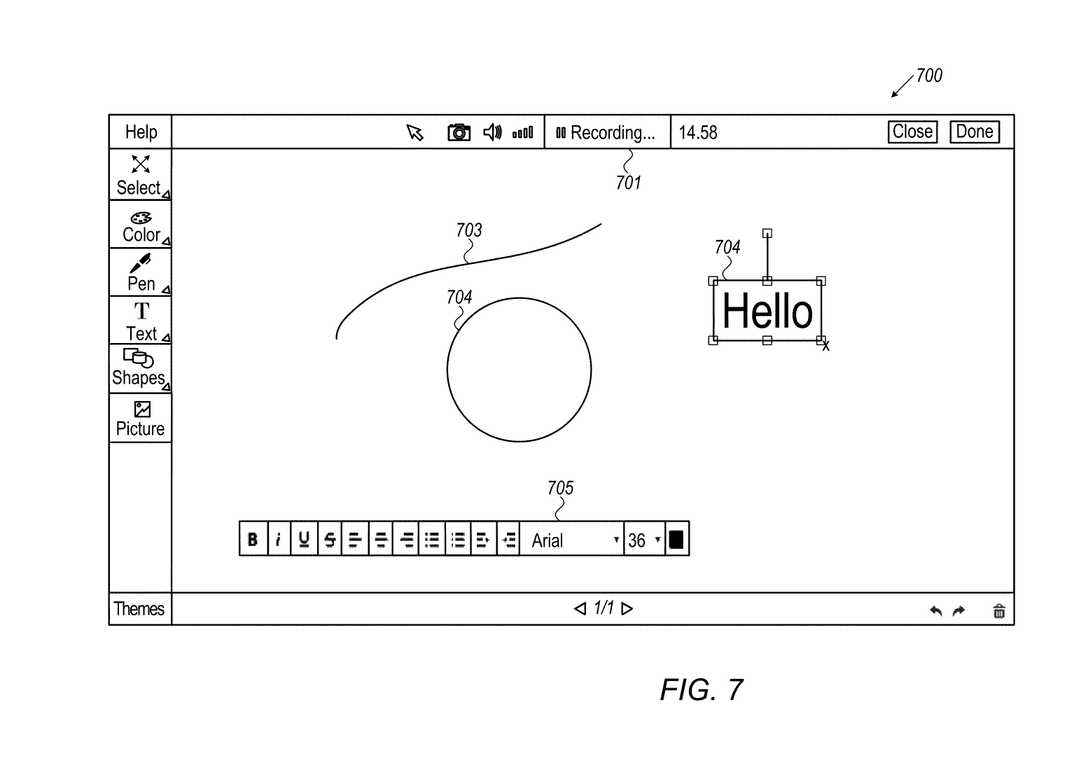

Reference is now made to FIG. 7, which is a screenshot 700 of a generalized whiteboard in a user uploading sketch 703 in an application, in accordance with an embodiment of the present invention. On the screen, there is seen a text message 702, a text toolbar 705 and a shape 704. Record icon 701 shows the whiteboard while capturing.

FIG. 8 shows a screenshot 800 of a generalized whiteboard in a user downloading lesson step in an application, in accordance with an embodiment of the present invention. On the screen there is a play button 804, which the user activates to see a text 801, a sketch 802 and a shape 803 uploaded by the first user. The second user hears the audio from the first, user, synchronized with the items uploaded by the first user.

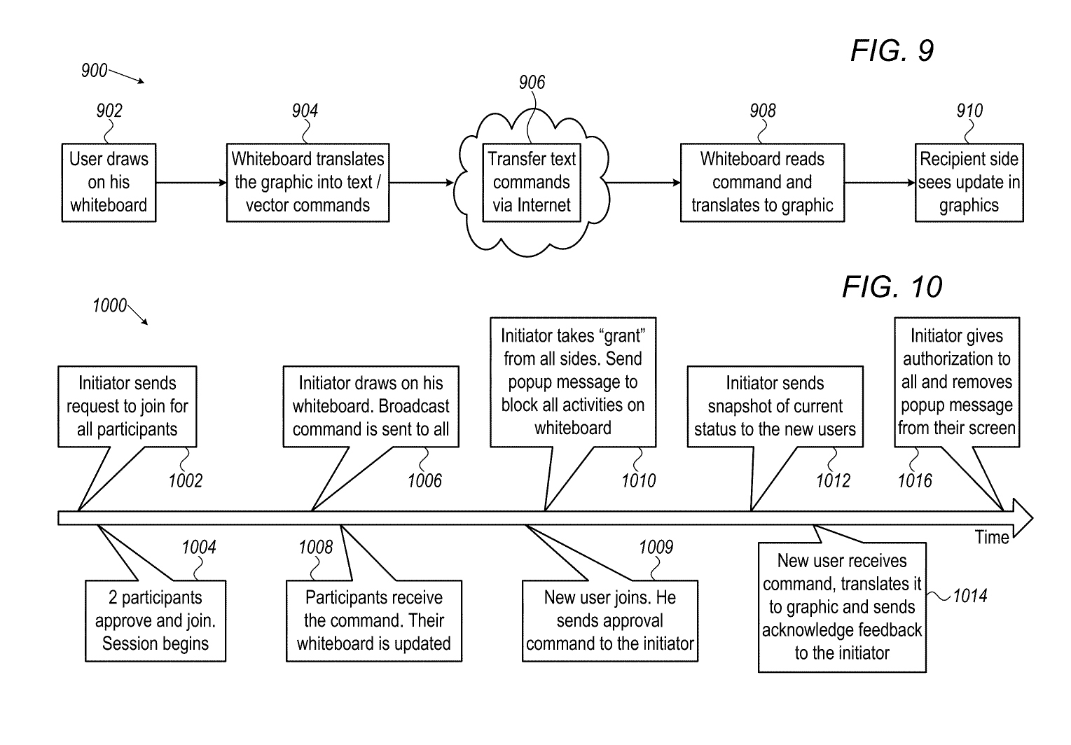

Reference is now made to FIG. 9, which is a simplified schematic flowchart 900 of an online communication between one-to-one or one-to-many peers. The method includes a graphic-to-text method part and text-to-graphic method part for transmitting information over a public network, in accordance with an embodiment of the present invention.

In a drawing step 902, a first user draws on his whiteboard (109, FIG. 1). The system (such as system 100 of FIG. 1) of the present invention is operative to translate the graphic drawn by the first user into a text vector in a graphic-to-text translation step 904. Thereafter, in a text transferring step 906, the text outputted from step 904 is transferred via a network such as the internet 103. A second whiteboard 111 receives the text from the internet and is configured to read the text command and convert it back into a graphic in a text-to-graphic step 908. The recipient is then able to view the update in graphics in a viewing graphics step 910.

Another application of the methods of the present invention enables bi-directional communication or multiple communications between peers.

FIG. 10 is a simplified schematic flowchart 1000 of a multi-participant session in a method for imparting information over a public network, in accordance with an embodiment of the present invention. This is based on the systems and methods herein which enable a conversion of user activities into text vectors, thereby allowing fast updated receipt thereof to a peer. The method performed in FIG. 10 is signaling done between the initiator of an online session and the receiving peer/s to establish such communications, in particular when not all receiving peers enter into the session at the same time, but all need to be updated/synchronized with the latest updated of the initiator.

The challenge is to update the new participants with the latest information while the other participants might have updated their whiteboards at the same time. To avoid such conflicts, the present invention online whiteboard uses the following techniques:
1. Only the initiator of the session can invite the participants—thus the initiator sends a request in an inviting step 1002.
2. one or more participants join the session and the session begins as described in step 1004.
3. The initiator draws on his whiteboard and the system broadcast to all
4. Any of the participant can draw on his board in parallel while broadcasting to all so all whiteboards are updated Simultaneously
5. A new user (newcomer) joins the group in a joining step 1009.
6. The initiator disables any new updates from the participants (including the initiator) in a participant whiteboard disabling step 1010.
7. The initiators take a snapshot of data from all pages of his/her whiteboard and sends them as a chunk of text commands only to the new participant in an updating new participant step 1012.
8. New users receive the latest snapshots and translate the command into graphics in a translating step 1014. Once completed, the new user's machine feedbacks the initiator that the update was completed.
9. Thereafter, the initiator releases the popup screen from all participants to enable then to update the system, in step 1016.

To support multiple users that can update their whiteboard simultaneously, the system of the present invention is configured to use the following techniques:

Each participant is using broadcast command to all concurrent users in the session no matter if they are the initiator or the participants. Each of the users has his/her own ID (per session) so each of the participants knows where the command came from.

An initiator can block updates from any or all participants by taking their “grant” status at any time and can return the grant at any time.

Based on the fact only short commands are sent between the participants and there are no conflict commands on the whiteboard, the whiteboard of all parts is performed in fractions of a second enabling real live emulated video.

Prior art software available today only enables sharing in one direction by sharing the screen of the session initiator with the participant, the present invention solution enables any to any updated in real time with fraction of the time and bandwidth it takes to share screen updates (see FIGS. 9-10 for further details herein).

According to some embodiments of the present invention, a whiteboard provided is a vector-based whiteboard. Every element in the whiteboard is described in a text manner to reduce size and time required for transmission (see FIGS. 14A and 14B for more details). One can see the online whiteboard as a machine that sends text vector with updates of a graphic on one user side to the other participant while the other participants' computers translate the text strings back into graphics as seen in FIG. 9.

Each of the participants can be sender and recipient at the same time. The system allows multiple updates from multiple users at the same time.

Another problem that the present invention provides a new solution to is the enablement of introducing a new participant to a live session (FIG. 10). In such a case, the other participants have updated whiteboards, whereas the newcomer has a blank whiteboard.

The present invention allows two people (or more) to collaborate together therewith, so when a first user 190 writes something, the other users 191, 192 see it and can also share his/her thoughts by sketching on the same/other whiteboard.

The present invention provides an application, based on HTML5 technology. It is the most attractive and new technology available today (prior art products are based on Flash technology). This provides another advantage for the present invention over the prior art since flash is only supported by PC. In contrast, HTML5 is a device agnostic (which means that the software application of the present invention is constructed and configured to be run on any tablets, smart phones, mobile device and PCs) without any change.

Additionally, the present invention provides an application which is constructed and configured to be used on all devices 101, 102, 107, 109 and 110.

FIG. 11 is a screenshot 1100 of a graphic element 1102 and an animated element 1104 on a whiteboard application, in accordance with an embodiment of the present invention. The graphic element may be a text, a picture, a shape or combinations thereof. It should be noted that the present invention allows formation of the animated element online in a single click and it is synchronized with the start and stop timing of the animation without need for a timeline (which is very complex and time consuming as it is performed in other prior art systems).

The person preparing the “video” can preset animated shape 1104 and start recording audio. Then when he/she clicks on the animated shape 1104 at time t₁, the pre-defined animation of the object or element 1104 will begin. Thus the person can prepare numerous on-screen “pre-animated” objects 1104 and activate each of them precisely it is required to match the audio in “one-click” each respectively.

The whiteboard has predefined animation functions such as a menu for fast, medium or slow play of the animation, fade-in, fade-out, wave, flip, change color and position, etc., which are set up for each animated object or element in the preparation of the lesson/video. Upon the one-click, the animated object will play in accordance with the preset instructions. The whiteboards of the present inventions make preparation of lessons/“video” much simpler and saves a lot of the person's time and efforts. The recipient will see the lesson with the animations activated at the time the person activated them (and will not see them beforehand).

The present invention users' only have to add the animation for pre-defined animation pool and set their location. The entity with the animation is shown to the video creator only but not recorded yet. A user will see the entity with the animation as dashed on the whiteboard. Once the user is ready to activate the pre-defined animation during record mode, he only needs to press a single click on this animation 1104 (FIG. 11) and the animation will start to work. The record writes the time the animation starts and the time it ends. For users who run the movie afterwards, the movie looks like the animated element which enters in the right timing and ends on the right timing. The user (who creates the video) can run the animation again and again while the recorder is still running.

The main benefit of this method is the simplicity of adding animations with similar effect of complex animation building done today (prior art).

The present invention supports use of a whiteboard with text and shapes. This allows the present invention to be the only tool in the market today enabling a video creator to prepare a emulate-video with no hardware (such as a sketch board with digital pen) or the need to use a tablet with touch screen).

Additionally, the present invention provides a formula editor support 612 (FIG. 6), thus enabling a teacher/user to provide exact science data and formula.

Additionally, the present invention provides different set of tools (onscreen icons (not shown) for different subjects. These include, but are not limited to a map generator for geography, a graph generator for science, an equation solver and dynamic movement of object to simulate physics, for example, (which are all translated into a user's vector text and decoded to graphic at the user side).

The software application of the present invention enables a user to generate a video in a single click one he/she finished to sketch and record.

The whiteboard of the present invention supports text insertion and predefined shapes so user will be able to use a keyboard and a mouse to generate very accurate text and shapes. Comparing to prior art products on the market, which require a digital board to make accurate lines that requires for text writing or shape drawing, the unique whiteboard of the present invention removes this need, since it comprises text and shape generators.

Additionally, in the present invention, since the audio is recorded in parallel with the activities performed on the whiteboard by one or more users, the whiteboard is constructed and configured to synchronize between the audio and activities over time. A CPU clock is also sampled to make sure there will be zero drift over the time even when the system overloads the CPU (FIG. 12).

The systems of the present invention provide the advantage that there is no need for two software package applications (one for tablets and one for PCs).

The software application of the present invention enables the setting up of a private lesson (one initiator with one or more participants). This invention further enables a combined collaboration tool sharing the same screen and can sketch at the same time with the ability to record it. This is also unique approach of the present invention. In other words, a paid lesson using the interactive tool of the present invention, also records for later review by the participants in live session.

Being able to record changes over time with audio line (although they are two separate files) enables whiteboard users to project both audio and associated whiteboard activities over time, such that they are fully synchronized. This makes the user see the vectors file and audio and a movie over time.

Currently, one of the whiteboard applications of the present invention is that of education purposes, such that a tutor can record a lesson in a very simple way without the need for special hardware for the software installed.

There are other applications in which the whiteboard of the present invention can be used, such as, but not limited to, customer support where the customer or the service providers want to explain something that requires voice with sketching over time to make the point much more comprehensive; sales personal, artistic, engineers and other people who need to sketch and talk while document the changes they are doing will help them to explain their point more clearly.

The whiteboard of the present invention can be used as a collaboration tool between two or more people that can use online audio transfer with sketch board that is common to all and everything is then recorded for later view of the parties. Using text to send the changes made over the whiteboard enable fast and reliable communication even when there is a slow internet connection.

The whiteboard of the present invention can be used as a video blog for blogger that wish to deliver message in graphic way instead or in addition to writing long text articles.

In some cases, a user or recipient downloads a lesson from library 170 (FIG. 1), such as in step 401 (FIG. 4).

All user activities on whiteboards (600, 700, 800) are documented in text log files (such as in library 170, FIG. 1). In order to maintain high resolution there is a need to document the activities in a very high clock rate. This makes a huge number of commands (Although the total size of the text files of the present invention is only fraction of the size of similar length video, the amount of commands in the text log file is huge).

No personal computer can process such amount of commands accumulated in one file unless it makes it step by step command.

Normally, the user sees a playback of an uploaded lesson as a video-like session. This video-like session is projected from the command line, which is actually an execution of step by step of the commands written at the activity log. But, if user orders the player to jump forward to a specific time, the system (100, FIG. 1, for example) needs to read all the instructions from the current point to the new point and executed them one by one on the whiteboard.

Step 401 of recipient download of a video, includes several sub-steps for fast-forwarding, exemplified by FIG. 13. Reference is now made to FIG. 13, which is a simplified schematic flowchart 1300 of a rapid method for fast-forwarding a video from a recipient side and to FIG. 14A is a simplified schematic illustration of a method for sorting text vectors into elements and their associated instructions over time, in accordance with some embodiments of the present invention.

In a first elements and text vector instructions sorting step 1302, all of n elements (such as 703, 704, FIG. 7, 1402, 1404, FIG. 14A) appearing on the canvas (such as 700, FIG. 7) are sorted into an array 1400 (FIG. 14A). Each element (E₁, 1402, E₂, 1404, E₃, 1406, E₄, 1408, E₅, 1410, up to . . . to E_{N}, 1412) may be a shape, line, text or other visually seen element. Each element comprises one or more associated instructions, such as shape instruction 1422, color instruction 1424, x, y, position instruction 1426, associated with a point in time. Array is constructed to organize the elements and their instructions over a timeline 1430 extending from the time at zero, denoted t₀ up to the end of the recording at time n, denoted tₙ.

FIG. 14B shows a simplified schematic illustration of a table of sorted elements 1450. Now the elements E₁, 1402, E₂, 1404, E₃, 1406, E₄, 1408, E₅, 1401, . . . to E_{N}, 1412, are organized such that all instructions 1422, 1424, 1426 appear along timeline 1430. Thus, if a snapshot 1455 is taken at time t₁, only instructions active at time t₁ appear in the snapshot.

The recipient then fast-forwards to time t₁, in a fast-forwarding step 1304. Time t₁ occurs at a time in between t₀ and tₙ.

System 100 (FIG. 1) is the operative to read all elements from t₀ to t₁, in an element reading step 1306.

System 100 (FIG. 1) is then operative to read all instructions from array 1450 at time t₁, in an instruction reading step 1308 associated with snap-shot 1455 (FIG. 14B).

In a displaying step 1310, the system is operative to execute and display all instructions (I_{E0,t0} . . . I_{EN,t1}) of time t₁ only.

Steps 1304-1310 take a fraction of the time it would take to execute all of the instructions from time t₀ to t₁ (that is all of array 1450 (FIG. 14B) from t₀ to t₁). If users instruct the system to jump forward from current time t to new time t+x then the system should read all commands over the x interval time and execute them in fraction of a second. To do so the present invention system opens a vector of instructions for any element. If there are several instructions for the specific element (i.e. for specific shape user instructs to move several times, change size and color) they are all aggregated to the same vector to hold the command per shape. None of the instructions is executed, but the system takes all instructions and splits them into vectors per element. When the user jumps to specific time, then the system is operative to rapidly read the instruction vectors per elements and execute it only once as the total result of each vector.

Reference is now made to FIG. 15, which is a simplified schematic flowchart 1500 of a rapid method for fast-reversing a video from a recipient side, in accordance with an embodiment of the present invention. It should be noted that the fast-back or fast-reverse method of the present invention (FIG. 15) differs from the fast forward method (FIG. 13).

For example, in a lesson which runs from t₀ to t_{N}, the user wishes to reverse or go back to a point t₁=(t_{N}−x). In a checking step 1502, system 100 is operative to check the lesson or “video” to see where t₁ is in the timeline t₀ to t_{N}. If point t₁ is near to t₀, then the time required to fast-forward from t₀ to t₁ may be less than the time taken to reverse/fast-backward from t_{N} to t₁. The system is operative to calculate the time required for both the above options.

Thereafter, in a decision step 1504, the system is operative to decide if the lesson should be reversed or restarted at t₀ and then fast forwarded from step 1302 FIG. 13. If the decision is not to reverse, then in step 1506, the application runs to step 1302 FIG. 13 to fast forward from t₀ to t_{N}. If the decision is to reverse (fast-backward) then steps 1508-1510 are performed. If the time between t_{N} and t₁ is m, then the system back-executes instructions of array 1450 of all elements from time T_{N} to time t_{(N-M)}=t₁ in a back executing step 1508. Thereafter the system executes instructions of time t₁, (I_{E0,t(n-m) to . . .} I_{EN,t(n-m)}) in an executing step 1510. This is a “reversed vector technique” So every second elapsed a vector of the command per element is filled with the instructions, which have already been executed. When user return backwards, the system calculates a pointer of each vector and makes an “undo” operation for each of the element to the designate location in time set by the user (step 1508). Then the system executes at once the vector per each element (step 1510).

### IMPROVEMENTS OF THE PRESENT INVENTION OVER THE PRIOR ART

1) Low bandwidth usage, relative to the prior art in which JPEG files are transferred sequentially, whereas the present invention only sends updates one or more command text lines to peers.

2) The methods of the present invention provide fast online delivery. Text is sent to all parties as it is broadcast. The text commands are translated into graphic on a user side and hence take one or more milliseconds to be transferred and translated back into text to enable real online collaboration.

3) The whiteboard applications of the present invention enable some or all activities to be recorded on a timeline using the whiteboard save mechanism, which keep a log of all activities with the time line (FIGS. 14A, 14B) so users can watch the session offline afterwards. As only the initiator is the first to join and last to drop form the session he establishes, the recording is done on his side and sent to the server along with the audio layer recorded independently and synchronized with the log file of the graphic instructions to create a synchronized “simulated” video movie afterwards.

4) Single-click animation

Prior-art animation creation is difficult, requires preliminary preparation and it is currently performed off-line. There are several prior-art tools in the market today that enable users to create animated video. All are using the same techniques of timeline. With the current techniques (timeline) user should set the entity's position at each second and predefine how the entity will move over time. This requires a lot of work and many iterations until users gets what he needs.

In sharp contrast, the present invention's approach is different and eliminates the need for a timeline. As the present invention uses a running clock (FIG. 12), all activities are recorded in real time and each activity has its own time tag.

The present invention thus provides an educational social network that is operative to revolutionize the ways students learn and tutors teach. The present invention provides a website at which the whiteboard can be viewed and used.

It has been found, that there is a lot of knowledge that people wish to share with others. However, before this invention there were limited means to do so. It should be noted that video are difficult and time consuming to create.

5) The present invention system and methods achieve HD video, which take up a fraction of the size of similar videos, due to the usage of text vectors instead of compressed JPEG pictures, as are done today with modern encoders, such as, but not limited to MP4 and others.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1. A system for improved multimedia file sharing over a public network, the system comprising:
a) an online application for uploading a compressed audio file (CAF) and a text vector (TV), which are synchronized over time by an internal first clock;
b) a public network for storing said compressed audio file (CAF) and a text vector (TV);
c) a tool for downloading said compressed audio file (CAF) and a text vector (TV) with an internal second clock, wherein said internal first clock and internal second clock are synchronized with a system clock to form a synchronized emulated video; and
d) a text vector sorting tool adapted to sort elements into an array over time and further to arrange all instructions associated with each element over said time.

2. A system according to claim 1, wherein said tool enables downloading to a device selected from the group consisting of a cellular phone, a Personal Computer (PC), a mobile phone, a mobile device, a computer, a speaker set, a television and a tablet computer.

3. A system according to claim 2, wherein said device further comprises a whiteboard display.

4. A system according to claim 3, wherein said system is constructed to extend an HTML5/Canvas standard library to support activities over time, synchronized to said compressed audio file (CAF).

5. A system according to claim 1, wherein said system clock is adapted to disable an accumulative gap between two or more real-time activities

6. A method for improved multimedia files sharing over a public network, the method comprising:
a) uploading a pre-synchronized compressed audio file (CAF) and a graphic-to-text vector (GTT) to a public network;
b) storing said compressed audio file (CAF) and a graphic-to-text vector (GTT) on said public network; and
c) downloading said compressed audio file (CAF) and a text-to-graphics vector (TTG) to a user device, wherein said graphic-to-text vector (GTT) and said text-to-graphics vector (TTG) are synchronized internally and are both synchronized with a system clock to form a synchronized emulated video.

7. A method according to claim 6, wherein said method extends an HTML5/Canvas standard library to support activities over time synchronized to said compressed audio file (CAF).

8. A method according to claim 7, wherein said uploading step is performed in one click to create said synchronized emulated video.

9. A method according to claim 8, further comprising sorting text vectors by sorting elements into an array over time and further arranging all instructions associated with each element over said time (t₀ to tₙ).

10. A method according to claim 9, further comprising fast-forwarding said synchronized video to a point in time t₁, by:
a) taking a snapshot of all instructions active at time t₁ for all said elements; and
b) executing all said instructions at once.

11. A method according to claim 10, further comprising:
a) fast-reversing to a point in time t₁ by going to t₀,
b) taking a snapshot of all instructions active at time t₁ for all said elements; and
c) executing all said instructions.

12. A method according to claim 11, further comprising:
a) fast-reversing to a point in time t₁ by back-executing all instructions of all elements from tₙ to t₁; and
b) taking a snapshot of all instructions active at time t₁ for all said elements; and
c) activating all said instructions of step b).

13. A method according to claim 6, wherein said synchronized video is activated in one-click.

14. A method according to claim 6, further comprising:
f) repeating steps a) to c) in an online session; and
g) introducing a newcomer to said an online session by holding steps a) to c) until said newcomer is updated.

15. A method according to claim 14, wherein said synchronized emulated video creating emulated video requires a fraction of the size of a standard HD format.

16. A method according to claim 6, further comprising creating a one-click animation without usage of a timeline by the steps of:
i. creating a plurality of animation elements on a whiteboard, each with predefined animation attributes; and
ii. one-clicking on at least one of said elements at least one time to activate said predefined animation attributes associated with each said animation elements at a respective time in said online session.

17. A computer software product, said product configured for improved information sharing over a public network, the product comprising a computer-readable medium in which program instructions are stored, which instructions, when read by a computer, cause the computer to:
a) upload a pre-synchronized compressed audio file (CAF) and a graphic-to-text vector (GTT) to a public network;
b) store said compressed audio file (CAF) and a graphic-to-text vector (GTT) on said public network; and
c) download said compressed audio file (CAF) and a text-to-graphics vector (TTG) to a user device, wherein said graphic-to-text vector (GTT) and said text-to-graphics vector (TTG) are synchronized internally and are both synchronized with a system clock to form a synchronized emulated video.

18. A computer software product according to claim 17, wherein said product is adapted to extend an HTML5/Canvas standard library to support activities over time synchronized to said compressed audio file (CAF).

19. A computer software product according to claim 17, wherein said upload enables a one-click step to create said synchronized video.

20. A computer software product according to claim 17, wherein said product configured for improved information sharing over a public network, the product is extending the HTML5/Canvas standard library to support activities over time synchronized to audio file.
